(19) United States
(12) Patent Application Publication
(10) Pub. No.: US 2017/0288780 A1
(43) Pub. Date: Oct. 5, 2017

(54) OPTOELECTRONIC TRANSCEIVER ASSEMBLIES

(71) Applicant: Intel Corporation, Santa Clara, CA (US)

(72) Inventors: Myung Jin Yim, San Jose, CA (US); Quan A. Tran, Fremont, CA (US); SeungJae Lee, Seoul (KR); Sandeep Razdan, Burlingame, CA (US); Yigit O. Yilmaz, San Francisco, CA (US); Pradeep Srinivasan, Mountain View, CA (US); Jincheng Wang, Danville, CA (US); Ansheng Liu, Cupertino, CA (US)

(21) Appl. No.: 15/087,344

(22) Filed: Mar. 31, 2016

(51) Int. Cl. H04B 10/50; H01S 3/10; H01S 3/02; H01S 3/23

(52) U.S. Cl. CPC H04B 10/503; H01S 3/2375; H01S 3/10; H01S 3/025

(57) ABSTRACT

Apparatuses including integrated circuit (IC) optical assemblies and processes for fabrication of IC optical assemblies are disclosed herein. In some embodiments, the IC optical assemblies include an optical transmitter component electrically coupled to a first portion of a packaging substrate. The IC optical assemblies further include an optical transmitter driver component between the optical transmitter component and a second portion of the packaging substrate, wherein a first side of the optical transmitter driver component is electrically coupled to the optical transmitter component. The IC optical assemblies further include a plurality of bumps between a second side of the optical transmitter driver component and proximate the second portion of the packaging substrate, wherein the plurality of bumps are not directly coupled to the optical transmitter driver component.

### FIELD OF THE INVENTION

The present disclosure relates generally to the technical field of computing, and more particularly, to optoelectronic assemblies and methods for making them.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

Optical data transmission provides increased bandwidth and transfer speed capabilities between and among computers, servers, devices, boards, chips, and components using lower power than may be possible in electrical data transmission. However, fabrication and operation of optoelectronic devices associated with optical data transmission present additional challenges in thermal management, optical alignment, mechanical stability, materials compatibility, operational reliability, component sturdiness, and/or cost effectiveness. As the trend toward higher bandwidth performance and small form factor continues, packaging of optoelectronic devices, such as optical transceiver modules, are further pressed to be compact while addressing higher temperatures, stresses, alignment, cross talk, cost, power delivery, and/or integration challenges arising from their smaller size.

### BRIEF DESCRIPTION OF THE DRAWINGS

Embodiments will be readily understood by the following detailed description in conjunction with the accompanying drawings. The concepts described herein are illustrated by way of example and not by way of limitation in the accompanying figures. For simplicity and clarity of illustration, elements illustrated in the figures are not necessarily drawn to scale. Where considered appropriate, like reference labels designate corresponding or analogous elements.

FIG. 1 depicts a top view of an example optoelectronic assembly, according to some embodiments.

FIG. 2 depicts a top view of the optical transmitter component included in the optoelectronic assembly of FIG. 1, according to some embodiments.

FIG. 3 depicts a cross-sectional view of a portion of the optoelectronic assembly of FIG. 1, according to some embodiments.

FIG. 4 depicts an example process for fabricating at least a portion of the optoelectronic assembly of FIG. 1, according to some embodiments.

FIGS. 5A-5F depict example cross sections of the optoelectronic assembly of FIG. 1 during the process of FIG. 4, according to some embodiments.

FIGS. 6A-6C depict cross-sectional views of example optoelectronic assemblies, according to alternative embodiments.

FIG. 7 depicts a cross-sectional view of an example portion of an optoelectronic assembly, according to some embodiments.

FIG. 8 depicts an example process for fabricating at least a portion of the optoelectronic assembly of FIG. 7, according to some embodiments.

FIGS. 9A-9E depict example cross sections of the optoelectronic assembly of FIG. 8 during the fabrication process, according to some embodiments.

### DETAILED DESCRIPTION

Embodiments of apparatuses and methods related to integrated circuit (IC) assemblies are described. In embodiments, an IC assembly may include an optical transmitter component electrically coupled to a first portion of a packaging substrate; an optical transmitter driver component between the optical transmitter and a second portion of the packaging substrate, wherein a first side of the optical transmitter driver component is electrically coupled to the optical transmitter component. The IC assembly may further include a plurality of bumps between a second side of the optical transmitter driver component and proximate the second portion of the packaging substrate, wherein the plurality of bumps are not directly coupled to the optical transmitter driver component. These and other aspects of the present disclosure will be more fully described below.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

Optoelectronic assemblies described herein facilitate optical data transfer, for example without limitation, in high performance computing applications, board to board transfers, memory to central processing unit (CPU) transfers, chip to chip transfers, component to component transfers, processing applications, storage applications, data access applications, communication applications, and the like. In some embodiments, optoelectronic assemblies, such as optical transceiver modules, may be capable of 100 Gigabits per second (Gbps) or greater data transfer speeds.

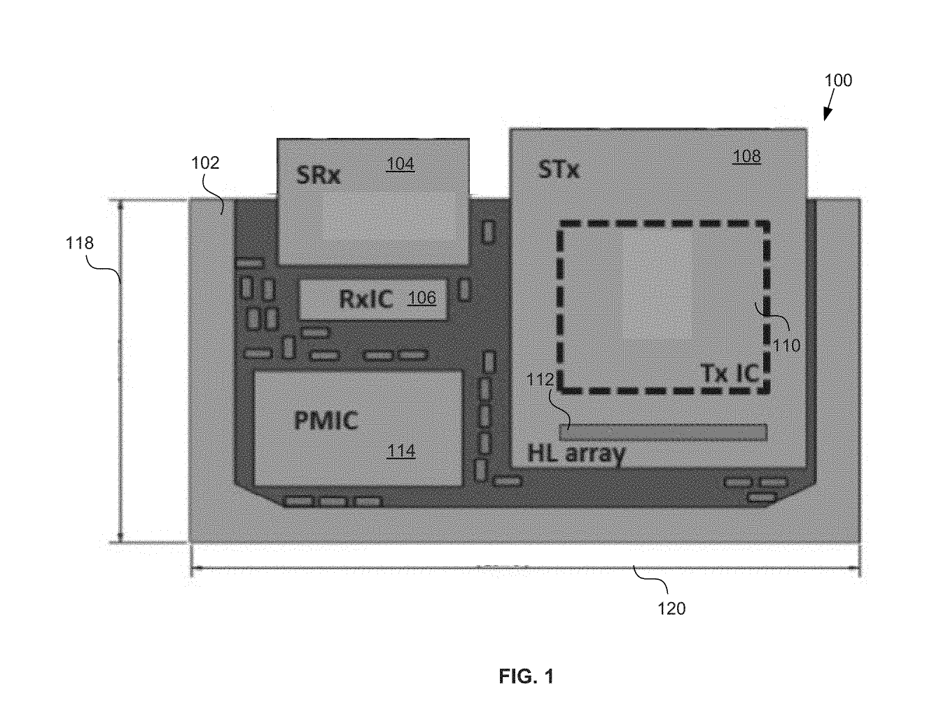

FIG. 1 depicts a top view of an example optoelectronic assembly 100, according to some embodiments. The optoelectronic assembly 100 may also be referred to as a silicon photonics module package, a high bandwidth optical module package, an optoelectronic assembly, an optical transceiver module, an optical transceiver assembly, an integrated circuit (IC) assembly, and the like. Optoelectronic assembly 100 may include a packaging substrate 102, an optical receiver component 104, an optical receiver driver component 106, an optical transmitter component 108, an optical transmitter driver component 110, and a power management component 114. As described in detail below, optoelectronic assembly 100 may comprise a stacked structure implementing chip-on-chip (CoC) and chip-on-substrate (CoS) interconnects with optical overhang.

In some embodiments, packaging substrate 102 may comprise a silicon-based substrate and may include one or more layers. Packaging substrate 102 may also be referred to as a substrate.

Optical receiver component 104 may be electrically coupled to a first portion of the packaging substrate 102, and partially overhang or extend past the packaging substrate 102 to receive optical transmissions. Optical receiver component 104 may comprise an IC, die, printed circuit board (PCB), or chip; and may include, without limitation, one or more photo-detecting or photo-receiving components. Optical receiver component 104 may also be referred to as a receiver, receiver component, receiver module, silicon photonics receiver (SRx) die, SRx sub-assembly, or the like. In some embodiments, optical receiver component 104 may comprise a silicon-based component.

Optical receiver driver component 106 may be electrically coupled to a second portion of the packaging substrate 102, and may be located proximate to the optical receiver component 104. Optical receiver driver component 106 may also be electrically coupled to the optical receiver component 104. Optical receiver driver component 106 may include, without limitation, circuitry capable of controlling the optical receiver component 104, processing data received by the optical receiver component 104, and/or converting optical signals received by the optical receiver component 104 into electrical signals. Optical receiver component 106 may comprise an IC, die, PCB, or chip. Optical receiver driver component 106 may also be referred to as a receiver IC (Rx IC), receiver driver, receiver driver module, receiver driver die, or the like.

Optical transmitter component 108 may be electrically coupled to a third portion of the packaging substrate, and partially overhang or extend past the packaging substrate 102 to transmit optical signals. Optical transmitter component 108 may include one or more light sources, such as a plurality of lasers 112. In some embodiments, the plurality of lasers 112 may comprise hybrid lasers (HLs) and may also be referred to as a laser array or HL array. For instance, each laser of the plurality of lasers 112 may operate in a wavelength range of 1270-1550 nanometer (nm). The optical signals transmitted by the optical transmitter component 108 may originate at the plurality of lasers 112, which may then be optically processed (e.g., collimated) before exiting the optical transmitter component 108. Optical transmitter component 108 may comprise an IC, die, PCB, or chip. Optical transmitter component 108 may also be referred to as a transmitter, transmitter component, transmitter module, silicon photonics transmitter (STx) die, STx sub-assembly, or the like. In some embodiments, optical transmitter component 108 may comprise a silicon-based component. In some embodiments, optical transmitter component 108 may include a number of bumps to provide thermal dissipation, mechanical stability, fabrication ease, and/or material stress management functions for the optoelectronic assembly 100, and in particular, for the transmitter sub-assembly, to be described more fully below.

Optical transmitter driver component 110 may be located in a cavity formed by the optical transmitter component 108. In some embodiments, optical transmitter driver component 110 may electrically couple to the optical transmitter component 108 in a flip-chip arrangement, disposed on the underside of or below the optical transmitter component 108, as described in detail below. Optical transmitter driver component 110 may be located over a fourth portion of the packaging substrate 102. Optical transmitter driver component 110 may include, without limitation, circuitry capable of controlling the optical transmitter component 108, preparing data to be transmitted by the optical transmitter component 108, converting electrical signals into optical signals for transmission, and/or otherwise facilitate operation of the optical transmitter component 108. Optical transmitter driver component 110 may comprise an IC, die, PCB, or chip. Optical transmitter driver component 110 may also be referred to as a transmitter IC (Tx IC), transmitter driver, transmitter driver module, transmitter driver die, or the like.

Power management component 114 may be electrically coupled to a fifth portion of the packaging substrate 102. Power management component 114, also referred to as a power management IC (PMIC), may include circuitry capable of managing power (e.g., regulate power, provide power, etc.) for the assembly 100 and/or for one or more of the optical receiver component 104, optical receiver driver component 106, optical transmitter component 108, or optical transmitter driver component 110. Power management component 114 may comprise an IC, die, PCB, or chip.

In some embodiments, the optoelectronic assembly 100 may have a first dimension 118 of 13.42 millimeter (mm) or approximately 13 mm, and a second dimension 120 of 20.95 mm or approximately 21 mm. The amount of overhang of the optical receiver component 104 from the packaging substrate 102 may be 2.4 mm or approximately 2 mm. The amount of overhand of the optical transmitter component 108 from the packaging substrate 102 may be 2.7 mm or approximately 3 mm.

In some embodiments, optoelectronic assembly 100 may be electrically coupled to one or more components, such as, but not limited to, processor(s), capable of providing electrical signals to be converted and transmitted as optical signals by the optoelectronic assembly 100 and/or to receive electrical signals after conversion from photonic form received by the optoelectronic assembly 100. In turn, the processor(s) and the optoelectronic assembly 100 may be included in an apparatus or device, such as, but not limited to, smartphones, tablets, Internet of Things (IoT) devices, wearable devices, laptops, computers, workstations, servers, scanners, set top boxes, game consoles, mobile devices, and the like.

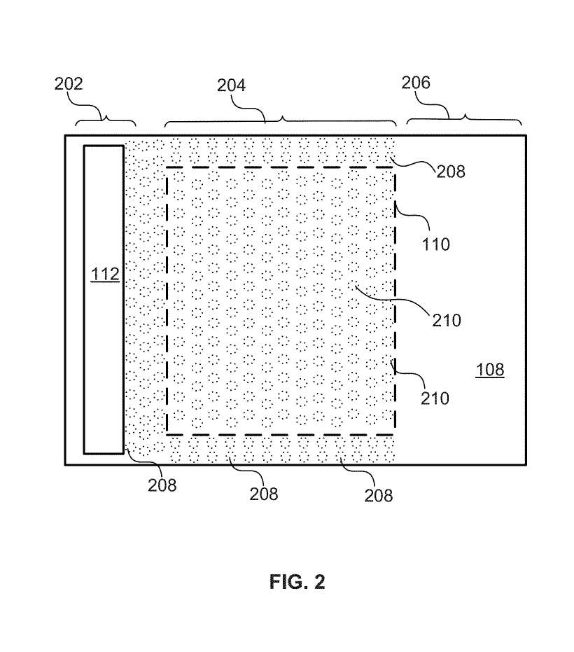

FIG. 2 depicts a top view of the optical transmitter component 108, according to some embodiments. Optical transmitter component 108, in some embodiments, may include three functional areas: a laser area 202, a driver area 204, and an optical output area 206. The laser area 202 may be located furthest from the overhang region of the optical transmitter component 108, and include the plurality of lasers 112.

The driver area 204 may include the optical transmitter driver component 110 and a plurality of bumps 208 and a plurality of bumps 210. Driver area 204 may be located in between the laser area 202 and the optical output area 206. Bumps 208 may be located proximate one or more sides (e.g., three sides) of the optical transmitter driver component 110 below the optical transmitter component 108. In FIG. 2, some of the bumps 208 are shown located between the plurality of lasers 112 and the optical transmitter driver component 110. Bumps 210 may be located below the optical transmitter driver component 110.

In some embodiments, bumps 208 and 210 may comprise structures capable of providing thermal dissipation, mechanical stability, fabrication ease, and/or material stress management functions for the optoelectronic assembly 100, and in particular, for the transmitter sub-assembly. Each of the bumps 208, 210 may comprise a structure having a certain height and width and may include conductive material(s). Bumps 208 and 210 may also be referred to as pillars, posts, pins, protrusions, dummy bumps (e.g., because they are not involved in electrical connections), or the like. In some embodiments, bumps 208 and/or 210 may be referred to as functional bumps, mechanical bumps, or wafer bumps. As described in detail below, bumps 208 and 210 may be included in the optoelectronic assembly 100 without the need to increase the transmitter sub-assembly area in the optoelectronic assembly 100 or the size of the packaging substrate 102. Because possible thermal buildup, mechanical stresses, and/or material stresses associated with the transmitter sub-assembly are spread out over a large number of bumps, at least the transmitter sub-assembly may also be at lower risk for incurring operational damage, such as, but not limited to, interlayer dielectric (ILD) cracks or bump cracks.

For instance, the bump profile or characteristics associated with the optical transmitter component 108, with inclusion of the bumps 208 and 210, may be as provided in the second row of the table below. In this example, the transmitter sub-assembly may be capable of 16 channels×25 Gbps/channel or 16 channels×36 Gbps/channel data transfer performance. In contrast, when, for example, bumps 210 are not present, the bump profile or characteristics may be less desirable as provided in the third row of the table below. Note the bump density may increase from 7.32% to more than 8%, such as 12 to 22%. The resulting higher bump density lowers both ILD and bump crack risk.

| | | | | # of | Min | Bump | | | |
|---|---|---|---|---|---|---|---|---|---|
| | | | Die aspect | bumps | bump | diameter | Bump | ILD | Bump |
| | Si | Die size | ratio & size | (approx. | pitch | and | density | crack | crack |
| Die | node | (mm × mm) | (mm²) | min/max) | (μm) | material | (%) | risk | risk |
| STx | 0.13 μm | 13.202 × 9.36 | 1.41/123.57 | 730 | 250 | 0.146 SnAg | 12.43-22.66 | Low | Low |
| | silicon on | | | 1071 | 83 | 0.052 Ni/SnAg | | | |
| | insulator | | | | | | | | |
| | (SOI) | | | | | | | | |
| STx | 0.13 μm | 13.202 × 9.36 | 1.41/123.57 | 430 | 250 | 0.146 SnAg | 7.32 | High | Medium |
| | silicon on | | | 1071 | 83 | 0.052 Ni/SnAg | | | |
| | insulator | | | | | | | | |
| | (SOI) | | | | | | | | |

The optical output area 206 may be located in the same area (or approximately the same area) as the overhanging portion of the optical transmitter component 108. Optical output area 206 may be located on the opposite end of the laser area 202. The optical output area 206 may include one or more optical components such as, but not limited to, optical couplers, lenses, mirrors, collimators, phase shifters, and the like to transform the laser light from the plurality of lasers 112 suitable for transmitting data along a pre-determined optical pathway to be appropriately received by an optical receiver.

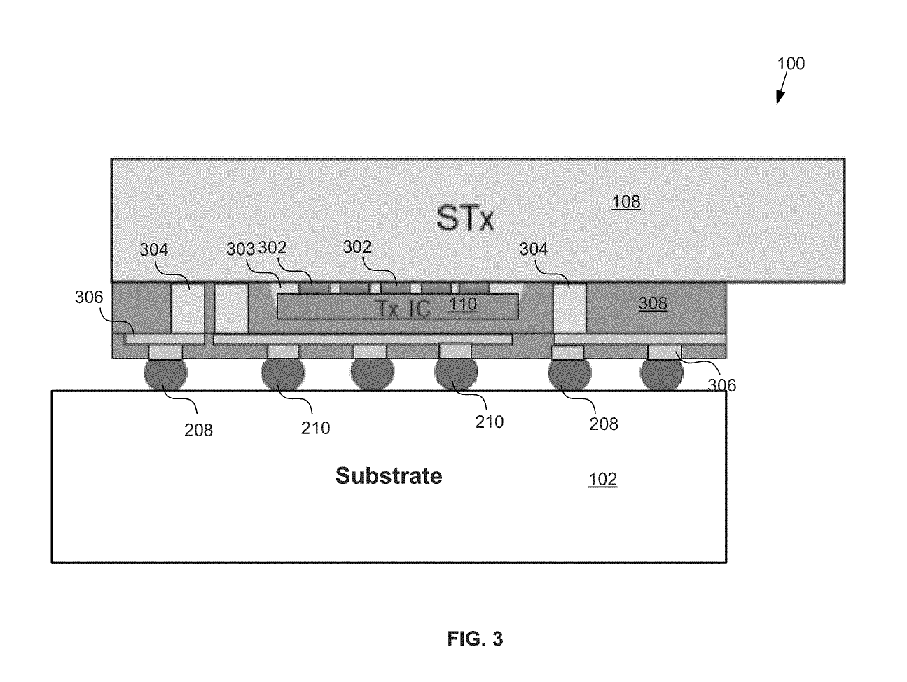

FIG. 3 depicts a cross-sectional view of a portion of the optoelectronic assembly 100, according to some embodiments. The optical transmitter driver component 110 may be disposed between the optical transmitter component 108 and the packaging substrate 102. The plurality of bumps 208 and 210 may be disposed between the optical transmitter driver component 110 and the packaging substrate 102.

In some embodiments, the optical transmitter driver component 110 may be electrically coupled to the optical transmitter component 108 via a plurality of electrical connectors 302 (e.g., solder balls) located between the optical transmitter driver component 110 and the optical transmitter component 108. Such an arrangement may be referred to a chip-on-chip (CoC) flip-chip arrangement or assembly. Also included between the optical transmitter component 108 and the optical transmitter driver component 110 may be an underfill layer 303, which may occupy the space not taken up by the plurality of electrical connectors 302.

Also coupled to the underside of the optical transmitter component 108 may be a plurality of posts 304 that may have a height or thickness at least slightly greater than the combined height/thickness of the plurality of electrical connectors 302 stacked above the optical transmitter driver component 110. The plurality of posts 304 may be located around the optical transmitter driver component 110, and may serve to form (part of) a cavity in which the optical transmitter driver component 110 may be located in the optoelectronic assembly 100 without taking up a dedicated portion of the package substrate 102. In some embodiments, the plurality of posts 304 may be referred to as wafer bumps, and may comprise a metallic or conductive material.

One end of each of the plurality of posts 304 may be coupled to the underside of the optical transmitter component 108 while the opposite end of each of the plurality of posts 304 may be coupled to conductive traces 306 (also referred to as conductive structures). The side of the conductive traces 306 furthest from the optical transmitter component 108, in turn, may be coupled to respective ones of the plurality of bumps 208 and 210. Among other things, the posts 304, conductive traces 306, and bumps 208/210 form thermal dissipation pathways for the transmitter sub-assembly. They may also provide structural support to aid in mechanical stability and/or material stress management for the transmitter sub-assembly.

A passivation layer 308 may be located between the optical transmitter component 108 and the plurality of bumps 208, 210. As shown in FIG. 3, the passivation layer 308 may exist in all (or substantially all) of the spaces within a stack structure created between the optical transmitter component 108 and the plurality of bumps 208, 212 not occupied by the optical transmitter driver component 110, plurality of connectors 302, and plurality of posts 304. In some embodiments, the passivation layer 308 may comprise a polymer material or a dielectric material.

Bumps 208 and 210 may be coplanar with each other and be of the same (or similar) height to each other. Bumps 208 and 210 may be collectively referred to as substrate bumps. In some embodiments, bumps 210 may comprise a metallic material, a conductive material, a tin and silver compound material, a nickel, tin, and silver compound material, a copper material, and the like.

In some embodiments, the optical transmitter component 108, electrical connectors 302, posts 304, optical transmitter driver component 110, conductive traces 306, passivation layer 308, bumps 208, and bumps 210 may collectively comprise the transmitter sub-assembly. The transmitter sub-assembly, in turn, may be disposed above the packaging substrate 102. The side of the bumps 208 and 210 opposite the side coupled to the conductive traces 306 may be in close proximity to or in physical contact with the packaging substrate 102. Although not shown, at least the optical transmitter component 108 may be electrically coupled to the packaging substrate 102.

In some embodiments, the height or thickness of the passivation layer 308 may be approximately equal to or less than 100 micron; the height or thickness of the bumps 208 and/or 210 may be approximately 20 to 30 micron; and the height or thickness of structures stacked between the optical transmitter component 108 and the packaging substrate 102 may be approximately 120 to 150 micron.

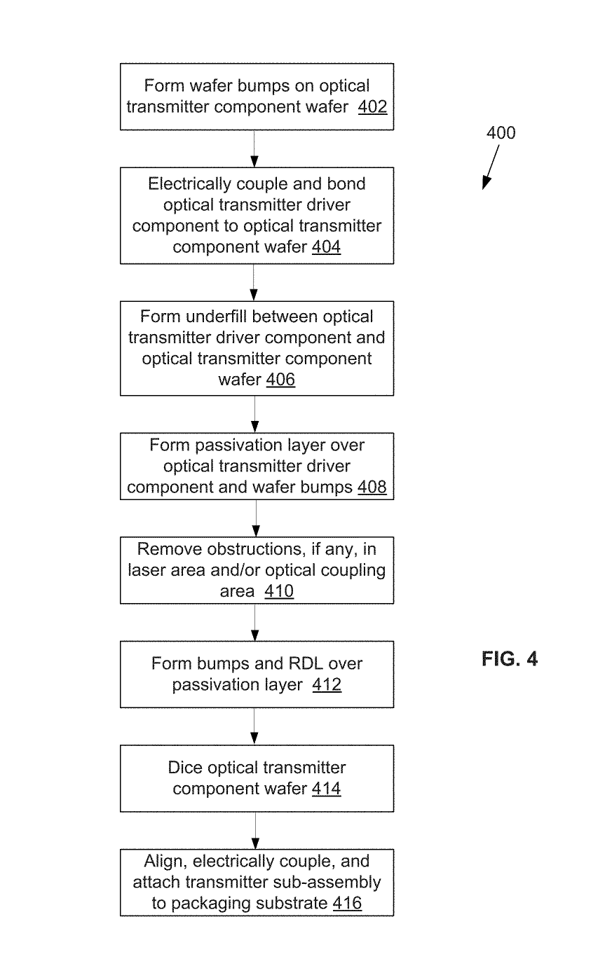

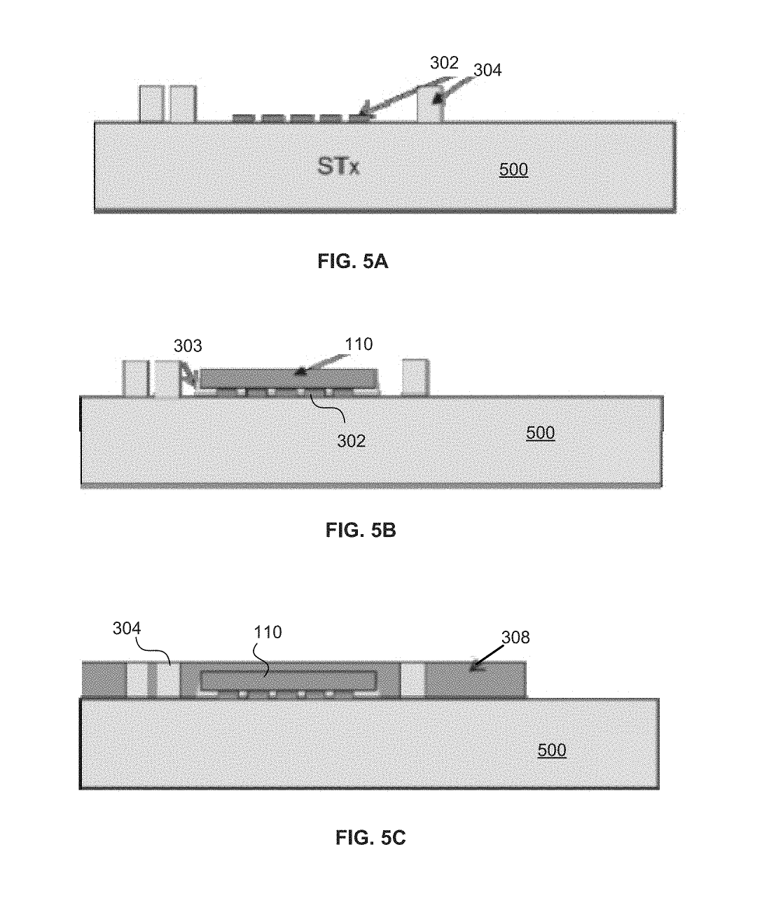

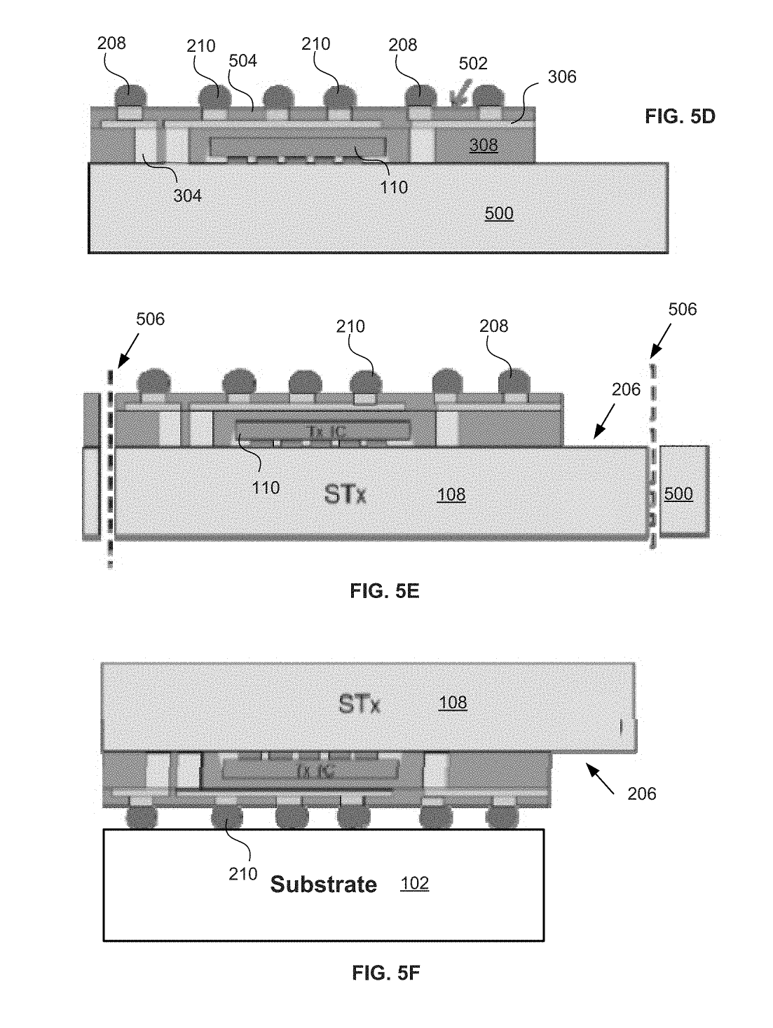

FIG. 4 depicts an example process 400 for fabricating at least a portion of the optoelectronic assembly 100, according to some embodiments. FIGS. 5A-5F depict example cross sections of the optoelectronic assembly 100 during the fabrication process. FIG. 4 is discussed below in conjunction with FIGS. 5A-5F.

At block 402 of FIG. 4 and as shown in FIG. 5A, wafer bumps may be formed on one side of a wafer 500 including the optical transmitter component 108 (also referred to as an optical transmitter component wafer). Wafer bumps, in some embodiments, may comprise the plurality of posts 304 and the plurality of electrical connectors 302. The height of each of the posts 304 may be greater than the height of each of the electrical connectors 302.

At block 404, the optical transmitter driver component 110 may be aligned, electrically coupled, and bonded to the wafer 500 at the plurality of electrical connectors 302. In some embodiments, a chip-on-wafer (CoW) assembly may be formed. In alternative embodiments, process 400 may include a testing operation after block 404, in which the optical transmitter component 108 and/or the optical transmitter driver component 110 may be tested after coupling with each other but before additional structures may be added.

As shown in FIG. 5B, the optical transmitter driver component 110 may be aligned over the plurality of electrical connectors 302. The space not occupied by the plurality of electrical connectors 302 between the optical transmitter driver component 110 and the portion of the wafer 500 directly below may be filled with the underfill layer 303, at block 406. In some embodiments, the underfill layer 303 may comprise polymer material, which may undergo mass reflow and capillary underfill process(es) or thermo-compression bonding by pre-applied material to form the underfill layer 303 at block 406.

Next at block 408, the passivation layer 308 may be formed over at least the optical transmitter driver component 110 and the wafer bumps (in particular, posts 304). As shown in FIG. 5C, the height or thickness of the passivation layer 308 may be the same or substantially the same as the height/thickness of the posts 304.

In some embodiments, the passivation layer 308 may be formed on one or more portions of the wafer 500 which may be less than desirable. For example, the material comprising the passivation layer 308 may migrate outside of designated areas during the forming process into areas of the wafer 500 corresponding to, for example, the laser area 202 and/or optical output area 206 of the optical transmitter component 108 included therein. Thus, at block 410, obstructions, if any, from the laser area 202 and/or the optical output area 206 may be removed so that optical pathways associated with the laser area 202 and/or optical output area 206 may be unobstructed.

At block 412 and as shown in FIG. 5D, bumps 208 and 210, conductive traces 306, and additional passivation layer 504 may be formed over the passivation layer 308 and the tops of posts 304, in some embodiments. The conductive traces 306 and additional passivation layer 504 may comprise a redistribution layer (RDL) 502.

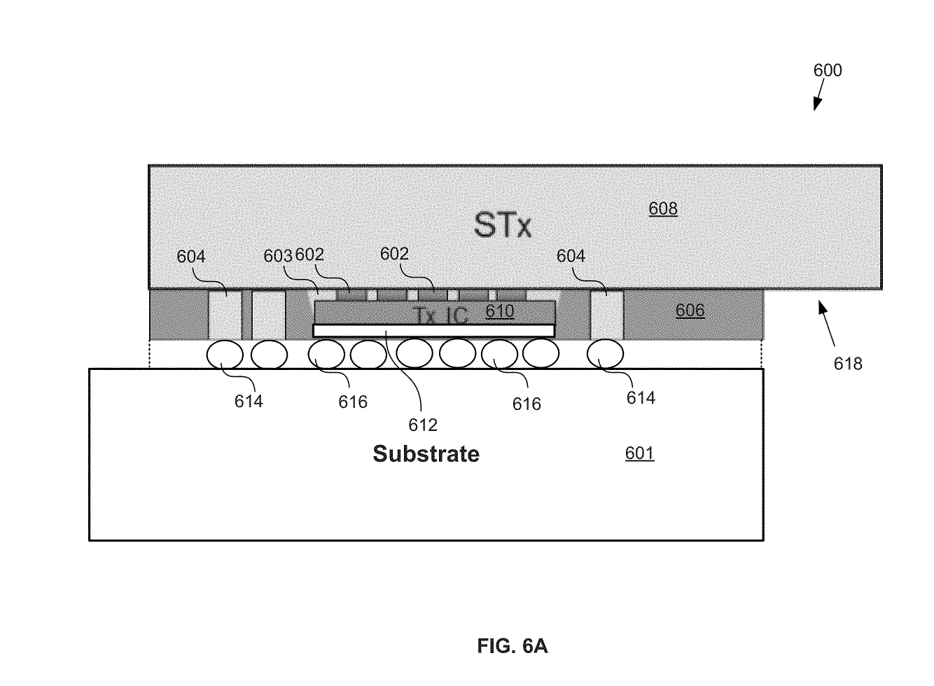

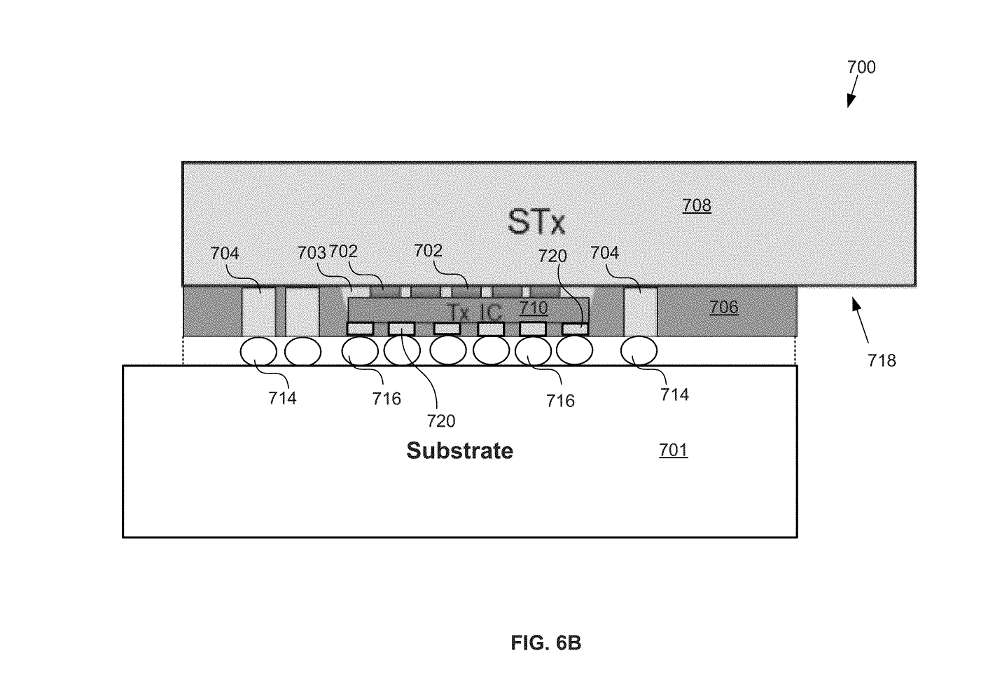

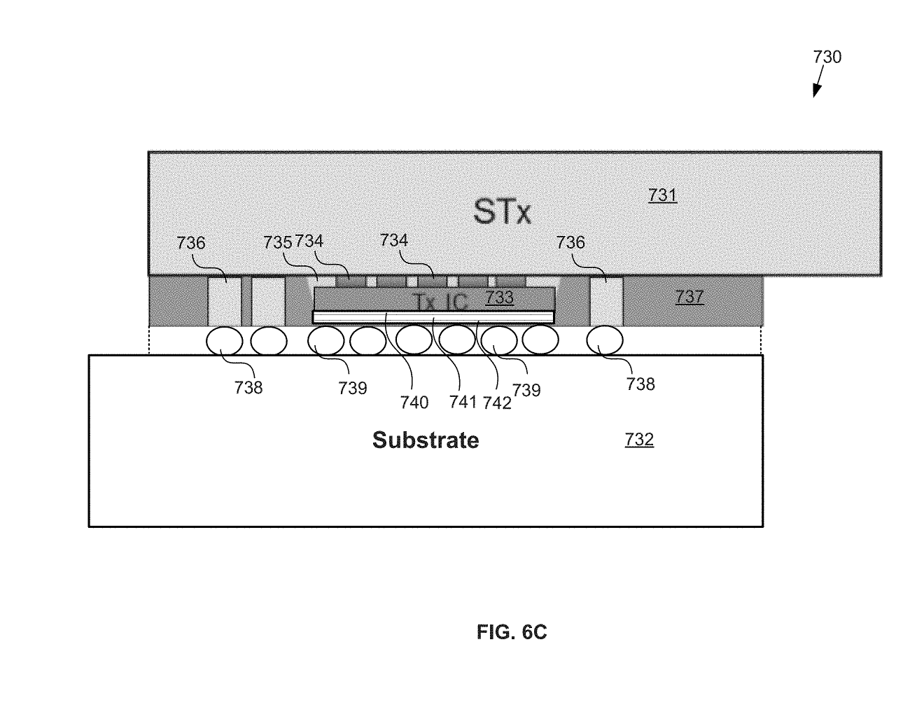

In alternative embodiments, as discussed in detail below with respect to FIGS. 6A-6C, the passivation layer 308 may be removed from areas directly above the optical transmitter driver component 110 (or not deposited over the optical transmitter driver component), and rather than form conductive traces 306, a metallization layer or structure (e.g., backside metallization layer 612 in FIG. 6A, backside metallization pattern layer 720 in FIG. 6B, or a metallic lamination structure in FIG. 6C) may be formed directly over the optical transmitter driver component 110. In these alternatives, the metallization layer/structure may be disposed between and couple to each of the underside of the optical transmitter driver component 110 and the plurality of bumps 210.

In some embodiments, additional processes may be performed prior to block 414, such as wafer thinning process(es).

Next at block 414 and as shown in FIG. 5E, the wafer 500 with the structure discussed above it may be diced at locations 506 to form a transmitter sub-assembly. Although not shown, in some embodiments, wafer 500 may include a plurality of transmitter sub-assemblies, which may be formed simultaneously with each other via the process described herein, and then cut or diced into individual transmitter sub-assemblies as in block 414.

The transmitter sub-assembly may then be aligned, electrically coupled, and attached to the packaging substrate 102, at block 416. As shown in FIG. 5F, alignment may include flipping the transmitter sub-assembly relative to its orientation during fabrication such that the former tops of the plurality of bumps 210 may be proximate to or in contact with the packaging substrate 102 and the optical output area 206 overhangs the end of the packaging substrate 102. The transmitter sub-assembly may also be electrically coupled and attached to the packaging substrate 102 (not shown), which may be referred to as a chip-on-substrate (CoS) arrangement.

In this manner, silicon photonics transceiver modules may include bump density associated with at least the transmitter assembly which may be greater than 8% or on the order of approximately 12-23% without increasing the transmitter die or overall package size. The higher bump density may also provide better laser protection during one or more fabrication processes such as mass reflow and capillary underfill processes. Due to the larger number of thermal dissipation or mechanical bumps for the transmitter assembly, the ILD crack and/or bump crack risk may also be reduced from improved thermal and mechanical stress management provided by such thermal dissipation or mechanical bumps distributed over the majority (or upwards of vast majority) of the area of the transmitter assembly.

FIGS. 6A-6C depict cross-sectional views of example optoelectronic assemblies 600, 700, and 730 according to alternative embodiments. Optoelectronic assembly 600 may be similar to optoelectronic assembly 100 except as noted below. In FIG. 6A, optoelectronic assembly 600 may include an optical transmitter driver component 610 electrically coupled and bonded to an underside of an optical transmitter component 608 via a plurality of electrical connectors 602 in a flip-chip arrangement (similar to the optoelectronic assembly 100). Components 608 and 610 and electrical connectors 602 may be similar to respective components 108 and 110 and electrical connectors 302 shown in FIG. 3.

The space not occupied by the connectors 602 between the optical transmitter component 608 and optical transmitter driver component 610 may be filled with an underfill layer 603. Underfill layer 603 may be similar to underfill layer 303 of FIG. 3. Optoelectronic assembly 600 may further include a plurality of posts 604 at the underside of the optical transmitter component 608, similar to posts 304 of FIG. 3.

In optoelectronic assembly 600, conductive traces 306 as shown in FIG. 3 may be omitted and instead, immediately below and coupled to the optical transmitter driver component 610 may be a backside metallization layer 612. In some embodiments, the backside metallization layer 612 may be a continuous or contiguous layer which may be the same or substantially the same area as the side of the optical transmitter driver component 610 closest to the backside metallization layer 612. The backside metallization layer 612 may comprise a metallic material or a conductive material; and may serve to act as a solder wetting layer. The backside metallization layer 612 may have a thickness or height in the range of 1 to approximately 30 micrometer (μm).

A plurality of bumps 614 and a plurality of bumps 616 may be disposed between the backside metallization layer 612 and posts 604 above and a package substrate 601 below. Each of the plurality of bumps 614, which may be similar to the plurality of bumps 208, may couple to a respective post 604. Each of the plurality of bumps 616, which may be similar to the plurality of bumps 210, may couple to a respective location on the underside of the backside metallization layer 612. Bumps 614 and 616 may be distributed under and around the optical transmitter driver component 610.

A passivation layer 606 may be provided between the optical transmitter component 608 and the packaging substrate 601. In some embodiments, the passivation layer 606 may have the same (or similar) height or thickness as the posts 604. In other embodiments, the passivation layer 606 may extend the full distance between the optical transmitter component 608 and the packaging substrate 601.

The transmitter sub-assembly formed by the stacked structure shown in FIG. 6A above the packaging substrate 601 may electrically couple and bond to the packaging substrate 601 with an overhang to accommodate an optical output area 618 of the optical transmitter component 608.

Referring to FIG. 6B, optoelectronic assembly 700 may be similar to optoelectronic assembly 600 of FIG. 6A except as noted below. Optoelectronic assembly 700 may include an optical transmitter component 708, an optical transmitter driver component 710, a plurality of electrical connectors 702, an underfill layer 703, a plurality of posts 704, a passivation layer 706, a plurality of bumps 714, a plurality of bumps 716, an optical output area 718, and a packaging substrate 701 disposed and coupled relative to each other similar to respective optical transmitter component 608, optical transmitter driver component 610, plurality of electrical connectors 602, underfill layer 603, plurality of posts 604, passivation layer 606, plurality of bumps 614, plurality of bumps 616, optical output area 618, and packaging substrate 601 as shown in FIG. 6A.

In optoelectronic assembly 700, a backside metallization pattern layer 720 may be disposed between the optical transmitter driver component 710 and the plurality of bumps 716. The backside metallization pattern layer 720 may be non-continuous across the underside of the optical transmitter driver component 610. Locations which may align with contact areas of respective bumps of the plurality of bumps 716 may define the pattern where material associated with the layer 720 may be present. The backside metallization pattern layer 720 may comprise a metallic material or conductive material. The backside metallization pattern layer 720 may have a thickness or height in the range of 1 to approximately 30 μm.

In FIG. 6C, optoelectronic assembly 730 may be similar to optoelectronic assembly 600 of FIG. 6A except as noted below. Optoelectronic assembly 730 may include an optical transmitter component 731, an optical transmitter driver component 733, a plurality of electrical connectors 734, an underfill layer 735, a plurality of posts 736, a passivation layer 737, a plurality of bumps 738, a plurality of bumps 739, and a packaging substrate 732 disposed and coupled relative to each other similar to respective optical transmitter component 608, optical transmitter driver component 610, plurality of electrical connectors 602, underfill layer 603, plurality of posts 604, passivation layer 606, plurality of bumps 614, plurality of bumps 616, and packaging substrate 601 as shown in FIG. 6A.

Optoelectronic assembly 730 may further include a metallic lamination structure disposed between the optical transmitter driver component 733 and the plurality of bumps 739. The metallic lamination structure may have a thickness or height in the range of 10-30 μm. The metallic lamination structure may also be referred to as a copper lamination structure. The metallic lamination structure may comprise a multi-layer structure including an adhesive film 740, a copper foil layer 741, and a protective film 742. The adhesive film 740 may be disposed closest to the optical transmitter driver component 733, the protective film 742 may be disposed closest to the plurality of bumps 739, and the copper foil layer 741 may be disposed between the adhesive film 740 and the protective film 742. In some embodiments the copper foil layer 741 may comprise a material other than copper such as another metallic metal or a conductive material.

The metallic lamination structure may be formed in the optoelectronic assembly 730 using a single lamination process similar to the process and tools used in non-conductive film (NCF) lamination. The adhesive film 740 may provide isolation between the optical transmitter driver component 733 and the copper foil layer 741, so that, for example, potential for current leakage may be reduced.

In some embodiments, the bump density associated with the optical transmitter component of each of the optoelectronic assemblies 600, 700, and 730 may be the same or similar to that of the optoelectronic assembly 100. Due to the distribution of a large number of bumps in each of optoelectronic assemblies 600, 700, and 730, in particular, bumps 616, 716, and 739, respectively, each of the optoelectronic assemblies 600, 700, and 730 may be capable of performance characteristics similar to that of optoelectronic assembly 100.

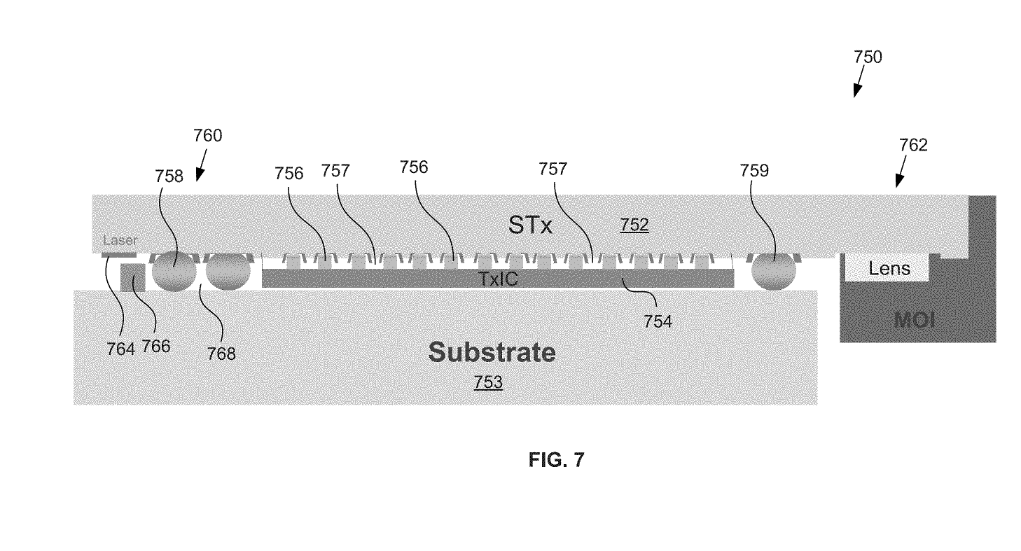

FIG. 7 depicts a cross-sectional view of an example portion of an optoelectronic assembly 750, according to still other embodiments. Optoelectronic assembly 750 may include an optical transmitter driver component 754 disposed between an optical transmitter component 752 and a packaging substrate 753. The optical transmitter driver component 754, optical transmitter component 752, and packaging substrate 753 may be similar to optical transmitter driver component 110, optical transmitter component 108, and packaging substrate 102.

A plurality of electrical connectors 756 may be disposed between the optical transmitter component 752 and the optical transmitter driver component 754. The optical transmitter component 752 and the optical transmitter driver component 754 may be electrically coupled and bonded to each other in a flip-chip arrangement via the plurality of electrical connectors 756, similar to that discussed above for optoelectronic assembly 100. The plurality of electrical connectors 756 may be similar to electrical connectors 302.

The space not occupied by the electrical connectors 758 between the optical transmitter component 752 and the optical transmitter driver component 754 may be occupied by an underfill layer 757. Underfill layer 757 may be similar to the underfill layer 303.

Also disposed between the optical transmitter component 752 and packaging substrate 753 may be a plurality of bumps 758 and a plurality of bumps 759. The plurality of bumps 758 may be located in or proximate to a laser area 760, while the plurality of bumps 759 may be located in or proximate to an optical output area 762. Laser area 760 and optical output area 762 may comprise areas of the optical transmitter component 752 which are located at opposite ends of the optical transmitter component 752. Plurality of bumps 758 and 759 may be similar to plurality of bumps 208, and may also be referred to as laser flip chip bumps in some embodiments. Each bump of the plurality of bumps 758 and 759 may provide a pathway for thermal dissipation and/or aid in mechanical stability or stress management.

Within the laser area 760, there may be included a plurality of lasers 764 such as, for example, an array of hybrid lasers similar to the lasers 112. In some embodiments, the plurality of lasers 764 (also referred to as a laser array), may be located in the end or as close as possible to one end or edge of the optical transmitter component 752 directly opposite the overhang area. For instance, the distance between the edge of the optical transmitter component 752 and the side of the plurality of lasers 764 closest to such edge may be approximately 500-1000 μm. Along a direction perpendicular to the stack formed by the optical transmitter component 752, optical transmitter driver component 754, and packaging substrate 753 (e.g., going from left to right in FIG. 7), the plurality of bumps 758 may be located between the plurality of lasers 112 and the optical transmitter driver component 754.

Optical output area 762 may include, without limitation, a silicon lens, a modular optical interface (MOI), a micro-lens array (MLA), an optical coupler, and/or other optical components.

An underfill layer 768 may be disposed between the optical transmitter component 752 and the packaging substrate 753. The underfill layer 768 may be located in the spaces not occupied by the electrical connections 756, optical transmitter driver component 754, bumps 758, and bumps 759. Underfill layer 768 may comprise polymer material.

In some embodiments, a laser protection dam 766 (also referred to as a laser protection post or barrier) may be located between the optical transmitter component 752 and packaging substrate 753, and coplanar with the bumps 758 and 759 in the perpendicular direction. Laser protection dam 766 may be located proximate to the lasers 764 and at least partially in between the lasers 764 and bumps 758 so that it may be capable of physically preventing the material comprising the underfill layer 768, during fabrication and/or laser operation, from extending to the lasers 764 and/or obstructing in any way the optical pathway(s) associated with the lasers 764. The laser protection dam 766 may extend along the length of the lasers 764 (e.g., extending into and out of the page). The laser protection dam 766 may be attached or coupled to the top of the packaging substrate 753 to serve as a physical barrier to the underfill layer 768. In some embodiments, as shown in FIG. 7, laser protection dam 766 need not extend the full distance between the bottom of the optical transmitter component 752 and the top of the packaging substrate 753. Instead, dam 766 may have a height or thickness less than the distance between the bottom of the optical transmitter component 752 and the top of the packaging substrate 753, at a height or thickness sufficient to contain the underfill layer 768. The laser protection dam 766 may comprise a polymer material, a dielectric material, or a non-conductive material.

The rest of the optoelectronic assembly 750, such the optical receiver component, optical receiver driver component, and PMIC, may be similar as described above for optoelectronic assembly 100.

In this manner, the laser area 760, and in particular, lasers 764, may be better protected from potential obstruction, damage, or performance degradation from adjacent structures, during the fabrication process and/or during transmitter operations. For example, solder joint forces and mechanical stresses that may be exerted on the laser area 760 caused by coefficient of thermal expansion (CTE) mismatch and/or flip-chip processes may be reduced. Laser area 760 may be amendable to fine tuning of NCF lamination on the optical transmitter driver component 754. The electrical performance of the transmitter sub-assembly may also be realized by the particular structure of the optoelectronic assembly 750. In some embodiments, optoelectronic assembly 750 may have improved reliability in laser performance, less thermal-mechanical stress concentration in at least the laser area 760, and/or smaller solder joint forces in at least the laser area 760, without degradation in electrical, thermal, optical coupling, and/or small package size associated with optical system-in-package (oSIP) modules such as the optoelectronic assembly 750.

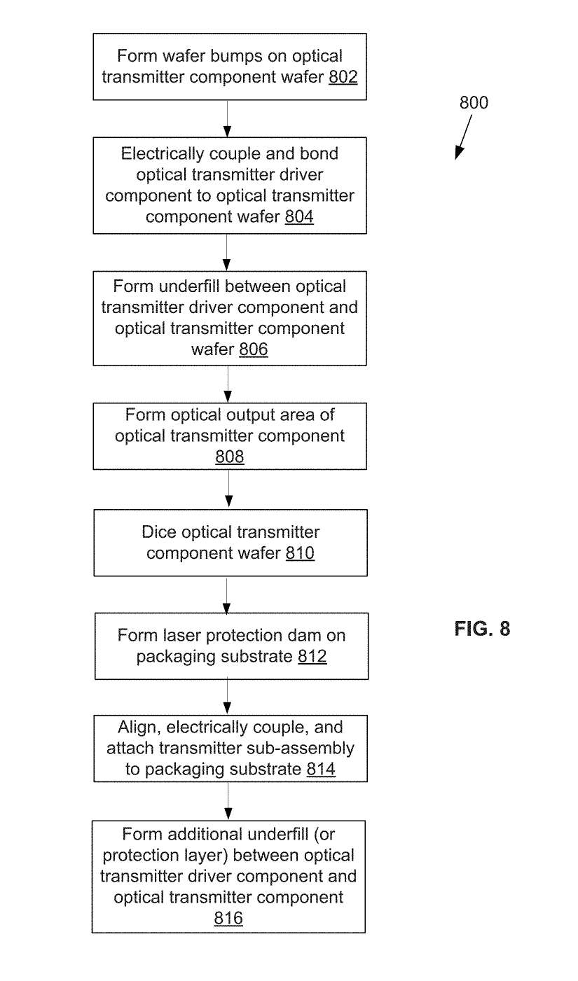

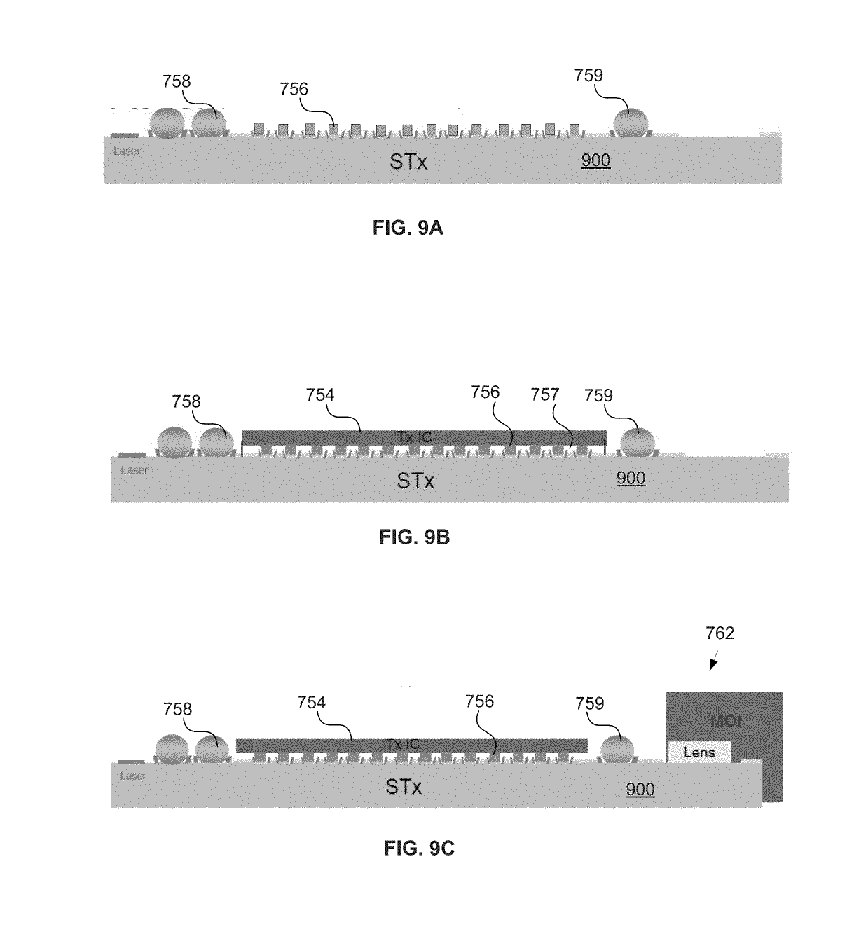

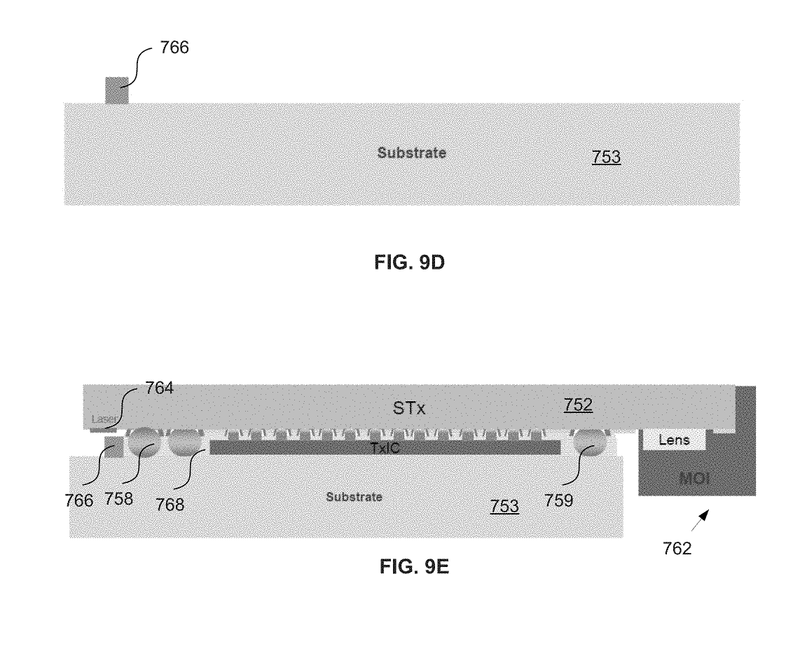

FIG. 8 depicts an example process 800 for fabricating at least a portion of the optoelectronic assembly 750, according to some embodiments. FIGS. 9A-9E depict example cross sections of the optoelectronic assembly 750 during the fabrication process, according to some embodiments. FIG. 8 is discussed below in conjunction with FIGS. 9A-9E.

At block 802 of FIG. 8 and as shown in FIG. 9A, wafer bumps may be formed on one side of a wafer 900 including the optical transmitter component 752 (also referred to as an optical transmitter component wafer). Wafer bumps, in some embodiments, may comprise the plurality of bumps 758 and 759 and the plurality of electrical connectors 758. The height of each of the bumps 758, 759 may be greater than the height of each of the electrical connectors 756.

At block 804, the optical transmitter driver component 754 may be aligned, electrically coupled, and bonded to the wafer 900 at the plurality of electrical connectors 756. In some embodiments, a chip-on-wafer (CoW) assembly may be formed. In alternative embodiments, process 800 may include a testing operation after block 804, in which the optical transmitter component 752 and/or the optical transmitter driver component 754 may be tested after coupling with each other but before additional structures may be added.

As shown in FIG. 9B, the optical transmitter driver component 754 may be aligned over the plurality of electrical connectors 756. The space not occupied by the plurality of electrical connectors 756 between the optical transmitter driver component 754 and the portion of the wafer 900 directly below may be filled with the underfill layer 757, at block 806. In some embodiments, the underfill layer 757 may comprise polymer material, which may undergo mass reflow and capillary underfill process(es) to form the underfill layer 757 at block 806.

At block 808, one or more optical components included in the optical output area 762 may be formed on and/or attached to wafer 900. For example, an optical silicon (MLA) and/or MOI assemblies may be formed on the wafer 900, as shown in FIG. 9C. At block 810, the wafer 900 with the structure above it may be diced to form a transmitter sub-assembly. Although not shown, in some embodiments, wafer 900 may include a plurality of transmitter sub-assemblies, which may be formed simultaneously with each other via the process described herein, and then cut or diced into individual transmitter sub-assemblies in block 810.

At block 812, the laser protection dam 766 may be formed on the top of the packaging substrate 753, as shown in FIG. 9D. In some embodiments, block 812 may be performed before or simultaneous with any of blocks 802-810.

At block 814, the transmitter sub-assembly may then be aligned, electrically coupled, and attached to the packaging substrate 753. As shown in FIG. 9E, alignment may include flipping the transmitter sub-assembly relative to its orientation during fabrication such that the former tops of the plurality of bumps 758, 759 may be proximate to or in contact with the packaging substrate 753 and the optical output area 762 overhangs the end of the packaging substrate 753. The transmitter sub-assembly may also be electrically coupled and attached to the packaging substrate 753 (not shown), which may be referred to as a chip-on-substrate (CoS) arrangement.

FIG. 9E also shows the underfill layer 768 formed between the optical transmitter component 752 and packaging substrate 753, at block 816. In some embodiments, the underfill layer 768 may be formed using mass reflow process(es) and may comprise an additional underfill layer or a protection layer for the bumps 758, 759 and/or adjacent optical component(s). As discussed above, the laser protection dam 766 prevents the underfill layer 768 from impinging on the lasers 764.

In alternative embodiments, the plurality of bumps 210 located under the optical transmitter driver component 110 in FIG. 3 may also be included in the optoelectronic assembly 750. As in FIG. 3, such plurality of bumps may be located between the optical transmitter driver component 754 and the portion of the packaging substrate 753 immediately below it. Such plurality of bumps may be coupled to the optical transmitter component 752 via conductive traces similar to conductive traces 306 in FIG. 3, or they may be coupled to the optical transmitter driver component 754 via a backside metallization layer similar to the backside metallization layer 612 of FIG. 6A or a backside metallization pattern layer similar to the backside metallization pattern layer 720 of FIG. 6B. In this manner, the optoelectronic assembly may enjoy improved laser protection and operation as well as improved thermal dissipation and/or mechanical stress management of at least the transmitter sub-assembly.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Illustrative examples of the devices, systems, and methods of various embodiments disclosed herein are provided below. An embodiment of the devices, systems, and methods may include any one or more, and any combination of, the examples described below.

Example 1 is an integrated circuit (IC) assembly including an optical transmitter component electrically coupled to a first portion of a packaging substrate; an optical transmitter driver component between the optical transmitter component and a second portion of the packaging substrate, wherein a first side of the optical transmitter driver component is electrically coupled to the optical transmitter component; and a plurality of bumps between a second side of the optical transmitter driver component and proximate the second portion of the packaging substrate, wherein the plurality of bumps are not directly coupled to the optical transmitter driver component.

Example 2 may include the subject matter of Example 1, and may further include a passivation layer between the optical transmitter component and the plurality of bumps; and a conductive structure between the optical transmitter component and the plurality of bumps, wherein the conductive structure is electrically coupled to the plurality of bumps.

Example 3 may include the subject matter of any of Examples 1-2, and may further include wherein a thickness of the plurality of bumps, the passivation layer, and the conductive structure is approximately 150 micron or less.

Example 4 may include the subject matter of any of Examples 1-3, and may further include wherein the plurality of bumps include a plurality of thermal dissipation bumps or a plurality of mechanical stability bumps.

Example 5 may include the subject matter of any of Examples 1-4, and may further include wherein a bump density of the plurality of bumps is greater than approximately 8%.

Example 6 may include the subject matter of any of Examples 1-5, and may further include wherein a thickness of the plurality of bumps is approximately 30 micron or less.

Example 7 may include the subject matter of any of Examples 1-6, and may further include wherein the plurality of bumps include metallic material or conductive material.

Example 8 may include the subject matter of any of Examples 1-7, and may further include wherein the optical transmitter component overhangs the packaging substrate.

Example 9 may include the subject matter of any of Examples 1-8, and may further include wherein the optical transmitter component outputs a light having a wavelength in the range of 1270-1550 nanometer (nm).

Example 10 may include the subject matter of any of Examples 1-9, and may further include wherein the optical transmitter component has a multi-channel data transfer speed of 25 Gigabits per second (Gbps) or 36 Gbps per channel.

Example 11 may include the subject matter of any of Examples 1-10, and may further include an optical receiver component electrically coupled to a third portion of the packaging substrate and overhanging the packaging substrate; an optical receiver driver component electrically coupled to a fourth portion of the packaging substrate and the optical receiver component; and a power management component electrically coupled to a fifth portion of the packaging substrate.

Example 12 may include the subject matter of any of Examples 1-11, and may further include wherein one end of the optical transmitter component includes a plurality of lasers, and further include a plurality of second bumps between the optical transmitter component and the packaging substrate, the plurality of second bumps disposed between the plurality of lasers and the optical transmitter driver component along a direction that is opposite to the one end of the optical transmitter component.

Example 13 may include the subject matter of any of Examples 1-12, and may further include a laser protection dam coupled proximate the second portion of the packaging substrate and disposed between the optical transmitter component and the packaging substrate; and an underfill between the optical transmitter component and the packaging substrate, the laser protection dam to prevent the underfill from contacting the plurality of lasers or obstructing an optical pathway associated with the plurality of lasers.

Example 14 may include the subject matter of any of Examples 1-13, and may further include wherein the plurality of second bumps includes metallic material or conductive material.

Example 15 may include the subject matter of any of Examples 1-14, and may further include a metallization layer positioned between and coupled to the optical transmitter driver component and the plurality of bumps, wherein the plurality of bumps couples to the second portion of the packaging substrate.

Example 16 may include the subject matter of any of Examples 1-15, and may further include wherein the metallization layer comprises a non-continuous layer.

Example 17 may include the subject matter of any of Examples 1-16, and may further include a metallic lamination structure positioned between the optical transmitter driver component and the plurality of bumps, wherein the metallic lamination structure includes an adhesive film, a copper foil layer, and a protective film.

Example 18 may include the subject matter of any of Examples 1-17, and may further include wherein the plurality of bumps comprises a plurality of first bumps and a plurality of second bumps, wherein the plurality of first bumps is located between the second side of the optical transmitter driver component and the second portion of the packaging substrate, the plurality of first bumps in contact with the second portion of the packaging substrate, and wherein the plurality of second bumps is located between at least one area adjacent to the second side of the optical transmitter driver component and at least one area adjacent to the second portion of the packaging substrate, the plurality of second bumps in contact with the at least one area adjacent to the second portion of the packaging substrate.

Example 19 is an apparatus including a processor; and an optoelectronic assembly electrically coupled to the processor, the optoelectronic assembly including an optical transmitter component electrically coupled to a first portion of a packaging substrate, an optical transmitter driver component between the optical transmitter component and a second portion of the packaging substrate, wherein a first side of the optical transmitter driver component is electrically coupled to the optical transmitter component, and a plurality of bumps between a second side of the optical transmitter driver component and proximate the second portion of the packaging substrate, wherein the plurality of bumps are not directly coupled to the optical transmitter driver component.

Example 20 may include the subject matter of Example 19, and may further include wherein the optoelectronic assembly further includes a passivation layer between the optical transmitter component and the plurality of bumps, and a conductive structure between the optical transmitter component and the plurality of bumps, wherein the conductive structure is electrically coupled to the plurality of bumps.

Example 21 may include the subject matter of any of Examples 19-20, and may further include wherein a thickness of the plurality of bumps, the passivation layer, and the conductive structure is approximately 150 micron or less.

Example 22 may include the subject matter of any of Examples 19-21, and may further include wherein the plurality of bumps include a plurality of thermal dissipation bumps or a plurality of mechanical stability bumps.

Example 23 may include the subject matter of any of Examples 19-22, and may further include wherein a bump density of the plurality of bumps is greater than approximately 8%.

Example 24 may include the subject matter of any of Examples 19-23, and may further include wherein a thickness of the plurality of bumps is approximately 30 micron or less.

Example 25 may include the subject matter of any of Examples 19-24, and may further include wherein the plurality of bumps include metallic material or conductive material.

Example 26 may include the subject matter of any of Examples 19-25, and may further include wherein the optical transmitter component overhangs the packaging substrate.

Example 27 may include the subject matter of any of Examples 19-26, and may further include wherein the optical transmitter component outputs a light having a wavelength in the range of 1270-1550 nanometer (nm).

Example 28 may include the subject matter of any of Examples 19-27, and may further include wherein the optical transmitter component has a multi-channel data transfer speed of 25 Gigabits per second (Gbps) or 36 Gbps per channel.

Example 29 may include the subject matter of any of Examples 19-28, and may wherein the optoelectronic assembly further includes an optical receiver component electrically coupled to a third portion of the packaging substrate and overhanging the packaging substrate, an optical receiver driver component electrically coupled to a fourth portion of the packaging substrate and the optical receiver component, and a power management component electrically coupled to a fifth portion of the packaging substrate.

Example 30 may include the subject matter of any of Examples 19-29, and may further include wherein one end of the optical transmitter component includes a plurality of lasers, and the optoelectronic assembly further includes a plurality of second bumps between the optical transmitter component and the packaging substrate, the plurality of second bumps disposed between the plurality of lasers and the optical transmitter driver component along a direction that is opposite to the one end of the optical transmitter component.

Example 31 may include the subject matter of any of Examples 19-30, and may further include wherein the optoelectronic assembly further includes a laser protection dam coupled proximate the second portion of the packaging substrate and disposed between the optical transmitter component and the packaging substrate, and an underfill between the optical transmitter component and the packaging substrate, the laser protection dam to prevent the underfill from contacting the plurality of lasers or obstructing an optical pathway associated with the plurality of lasers.

Example 32 may include the subject matter of any of Examples 19-31, and may further include wherein the optoelectronic assembly further includes a metallization layer positioned between and coupled to the optical transmitter driver component and the plurality of bumps, wherein the plurality of bumps couples to the second portion of the packaging substrate.

Example 33 may include the subject matter of any of Examples 19-32, and may further include wherein the metallization layer comprises a non-continuous layer.

Example 34 may include the subject matter of any of Examples 19-33, and may further include wherein the optoelectronic assembly further includes a metallic lamination structure positioned between the optical transmitter driver component and the plurality of bumps, wherein the metallic lamination structure includes an adhesive film, a copper foil layer, and a protective film.

Example 35 may include the subject matter of any of Examples 19-34, and may further include wherein the plurality of bumps comprises a plurality of first bumps and a plurality of second bumps, wherein the plurality of first bumps is located between the second side of the optical transmitter driver component and the second portion of the packaging substrate, the plurality of first bumps in contact with the second portion of the packaging substrate, and wherein the plurality of second bumps is located between at least one area adjacent to the second side of the optical transmitter driver component and at least one area adjacent to the second portion of the packaging substrate, the plurality of second bumps in contact with the at least one area adjacent to the second portion of the packaging substrate.

Example 36 may include the subject matter of any of Examples 19-35, and may further include wherein each of the optical transmitter component and the optical transmitter driver component comprises an integrated circuit (IC) chip.

Example 37 may include a method including forming a metallization layer proximate a side of an optical transmitter driver component that is furthest from an optical transmitter component; and forming a plurality of bumps below the optical transmitter driver component, wherein the plurality of bumps couple to the metallization layer and a substrate below the plurality of bumps.

Example 38 may include the subject matter of Example 37, and may further include electrically coupling and bonding the optical transmitter driver component to an underside of the optical transmitter component; and forming a passivation layer between the optical transmitter driver component and the metallization layer, and wherein forming the metallization layer comprises forming conductive traces.

Example 39 may include the subject matter of any of Examples 37-38, and may further include wherein forming the metallization layer comprises forming the metallization layer in contact with the side of the optical transmitter driver component that is furthest from the optical transmitter component.

Example 40 may include the subject matter of any of Examples 37-39, and may further include wherein forming the metallization layer comprises forming a non-continuous or a patterned metallization layer.

Example 41 may include the subject matter of any of Examples 37-40, and may further include wherein forming the metallization layer comprises forming a metallic lamination structure.

Example 42 may include the subject matter of any of Examples 37-41, and may further include wherein the metallic lamination structure includes an adhesive film, a copper foil layer, and a protective film.

Example 43 may include the subject matter of any of Examples 37-42, and may further include forming a plurality of second bumps adjacent to the plurality of bumps and not directly below the optical transmitter driver component, wherein the plurality of second bumps are coplanar with the plurality of bumps.

Example 44 may include the subject matter of any of Examples 37-43, and may further include wherein a bump density associated with the plurality of bumps and the plurality of second bumps is greater than approximately 8%.

Example 45 may include the subject matter of any of Examples 37-44, and may further include wherein the plurality of bumps include a plurality of thermal dissipation bumps or a plurality of mechanical stability bumps.

Example 46 may include the subject matter of any of Examples 37-45, and may further include wherein a thickness of the plurality of bumps is approximately 30 micron or less.

Example 47 may include the subject matter of any of Examples 37-46, and may further include wherein the plurality of bumps include metallic material or conductive material.

Example 48 may include an integrated circuit (IC) assembly including means for optically transmitting electrically coupled to a first portion of a packaging substrate; means for driving the means for optically transmitting between the means for optically transmitting and a second portion of the packaging substrate, wherein a first side of the means for driving is electrically coupled to the means for optically transmitting; and means for thermal dissipation between a second side of the means for driving and proximate the second portion of the packaging substrate, wherein the means for thermal dissipation are not directly coupled to the means for optically transmitting.

Example 49 may include the subject matter of Example 48, and may further include a passivation layer between the means for optical transmitting and the means for thermal dissipation; and means for conducting between the means for optically transmitting and the means for thermal dissipation, wherein the means for conducting is electrically coupled to the means for thermal dissipation.

Example 50 may include the subject matter of any of Example 48-49, and may further include wherein a thickness of the means for thermal dissipation, the passivation layer, and the means for conducting is approximately 150 micron or less.

Example 51 may include the subject matter of any of Example 48-50, and may further include wherein the means for thermal dissipation include a plurality of thermal dissipation bumps, a plurality of mechanical stability bumps, or a plurality of wafer bumps.

Example 52 may include the subject matter of any of Example 48-51, and may further include wherein a bump density of the means for thermal dissipation is greater than approximately 8%.

Example 53 may include the subject matter of any of Example 48-52, and may further include wherein a thickness of the means for thermal dissipation is approximately 30 micron or less.

Example 54 may include the subject matter of any of Example 48-53, and may further include wherein the means for thermal dissipation includes metallic material or conductive material.

Example 55 may include the subject matter of any of Example 48-54, and may further include wherein the means for optically transmitting has a multi-channel data transfer speed of 25 Gigabits per second (Gbps) or 36 Gbps per channel.

Example 56 is one or more computer-readable storage medium comprising a plurality of instructions to cause an apparatus, in response to execution by one or more processors of the apparatus, to include form a metallization layer proximate a side of an optical transmitter driver component that is furthest from an optical transmitter component; and form a plurality of bumps below the optical transmitter driver component, wherein the plurality of bumps couple to the metallization layer and a substrate below the plurality of bumps.

Example 57 may include the subject matter of Example 56, and may further include wherein the plurality of instructions, in response to execution by the one or more processors of the apparatus, further cause to electrically couple and bond the optical transmitter driver component to an underside of the optical transmitter component; and form a passivation layer between the optical transmitter driver component and the metallization layer, and wherein forming the metallization layer comprises forming conductive traces.

Example 58 may include the subject matter of any of Example 56-57, and may further include wherein to form the metallization layer comprises forming the metallization layer in contact with the side of the optical transmitter driver component that is furthest from the optical transmitter component.

Example 59 may include the subject matter of any of Examples 56-58, and may further include wherein to form the metallization layer comprises forming a non-continuous or a patterned metallization layer.

Example 60 may include the subject matter of any of Examples 56-59, and may further include wherein to form the metallization layer comprises forming a metallic lamination structure.

Example 61 may include the subject matter of any of Examples 56-60, and may further include wherein the metallic lamination structure includes an adhesive film, a copper foil layer, and a protective film.

Example 62 may include the subject matter of any of Examples 56-61, and may further include wherein the plurality of bumps include a plurality of thermal dissipation bumps or a plurality of mechanical stability bumps.

Example 63 is an optoelectronic package including an optical transmitter component electrically coupled to a first portion of a packaging substrate; an optical transmitter driver component between the optical transmitter component and a second portion of the packaging substrate, wherein a first side of the optical transmitter driver component is electrically coupled to the optical transmitter component; a plurality of bumps between a second side of the optical transmitter driver component and proximate the second portion of the packaging substrate, wherein the plurality of bumps are not directly coupled to the optical transmitter driver component; an optical receiver component electrically coupled to a third portion of the packaging substrate and overhanging the packaging substrate; an optical receiver driver component electrically coupled to a fourth portion of the packaging substrate and the optical receiver component; and a power management component electrically coupled to a fifth portion of the packaging substrate.

Example 64 may include the subject matter of Example 63, and may further include a passivation layer between the optical transmitter component and the plurality of bumps; and a conductive structure between the optical transmitter component and the plurality of bumps, wherein the conductive structure is electrically coupled to the plurality of bumps.

Example 65 may include the subject matter of any of Examples 63-64, and may further include wherein a thickness of the plurality of bumps, the passivation layer, and the conductive structure is approximately 150 micron or less.

Example 66 may include the subject matter of any of Examples 63-65, and may further include wherein the plurality of bumps include a plurality of thermal dissipation bumps or a plurality of mechanical stability bumps.

Example 67 may include the subject matter of any of Examples 63-66, and may further include wherein a bump density of the plurality of bumps is greater than approximately 8%.

Example 68 may include the subject matter of any of Examples 63-67, and may further include a metallization layer positioned between and coupled to the optical transmitter driver component and the plurality of bumps, wherein the plurality of bumps couples to the second portion of the packaging substrate.

Example 69 may include the subject matter of any of Examples 63-68, and may further include wherein the metallization layer comprises a non-continuous layer.

Example 70 may include the subject matter of any of Examples 63-69, and may further include a metallic lamination structure positioned between the optical transmitter driver component and the plurality of bumps, wherein the metallic lamination structure includes an adhesive film, a copper foil layer, and a protective film.

Example 71 may include the subject matter of any of Examples 63-70, and may further include wherein the plurality of bumps comprises a plurality of first bumps and a plurality of second bumps, wherein the plurality of first bumps is located between the second side of the optical transmitter driver component and the second portion of the packaging substrate, the plurality of first bumps in contact with the second portion of the packaging substrate, and wherein the plurality of second bumps is located between at least one area adjacent to the second side of the optical transmitter driver component and at least one area adjacent to the second portion of the packaging substrate, the plurality of second bumps in contact with the at least one area adjacent to the second portion of the packaging substrate.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

1. An integrated circuit (IC) assembly, comprising:
an optical transmitter component electrically coupled to a first portion of a packaging substrate;
an optical transmitter driver component between the optical transmitter component and a second portion of the packaging substrate, wherein a first side of the optical transmitter driver component is electrically coupled to the optical transmitter component; and
a plurality of bumps between a second side of the optical transmitter driver component opposite the first side of the optical transmitter driver component and proximate the second portion of the packaging substrate, wherein the plurality of bumps are not directly coupled to the optical transmitter driver component.

2. The IC assembly of claim 1, further comprising:
a passivation layer between the optical transmitter component and the plurality of bumps; and
a conductive structure between the optical transmitter component and the plurality of bumps, wherein the conductive structure is electrically coupled to the plurality of bumps.

3. The IC assembly of claim 1, wherein the plurality of bumps include metallic material or conductive material.

4. The IC assembly of claim 1, wherein the optical transmitter component has a multi-channel data transfer speed of 25 Gigabits per second (Gbps) or 36 Gbps per channel.

5. The IC assembly of claim 1, wherein one end of the optical transmitter component includes a plurality of lasers, and further comprising:
a plurality of second bumps between the optical transmitter component and the packaging substrate, the plurality of second bumps disposed between the plurality of lasers and the optical transmitter driver component along a direction that is opposite to the one end of the optical transmitter component.

6. The IC assembly of claim 5, further comprising:
a laser protection dam coupled proximate the second portion of the packaging substrate and disposed between the optical transmitter component and the packaging substrate; and
an underfill between the optical transmitter component and the packaging substrate, the laser protection dam to prevent the underfill from contacting the plurality of lasers or obstructing an optical pathway associated with the plurality of lasers.

7. The IC assembly of claim 1, further comprising a metallization layer positioned between and coupled to the optical transmitter driver component and the plurality of bumps, wherein the plurality of bumps couples to the second portion of the packaging substrate.

8. The IC assembly of claim 7, wherein the metallization layer comprises a non-continuous layer.

9. The IC assembly of claim 1, further comprising a metallic lamination structure positioned between the optical transmitter driver component and the plurality of bumps, wherein the metallic lamination structure includes an adhesive film, a copper foil layer, and a protective film.

10. The IC assembly of claim 1, wherein the plurality of bumps comprises a plurality of first bumps and a plurality of second bumps, wherein the plurality of first bumps is located between the second side of the optical transmitter driver component and the second portion of the packaging substrate, the plurality of first bumps in contact with the second portion of the packaging substrate, and wherein the plurality of second bumps is located between at least one area adjacent to the second side of the optical transmitter driver component and at least one area adjacent to the second portion of the packaging substrate, the plurality of second bumps in contact with the at least one area adjacent to the second portion of the packaging substrate.

11. An apparatus comprising:
a processor; and
an optoelectronic assembly electrically coupled to the processor, the optoelectronic assembly including an optical transmitter component electrically coupled to a first portion of a packaging substrate, an optical transmitter driver component between the optical transmitter component and a second portion of the packaging substrate, wherein a first side of the optical transmitter driver component is electrically coupled to the optical transmitter component, and a plurality of bumps between a second side of the optical transmitter driver component opposite the first side of the optical transmitter driver component and proximate the second portion of the packaging substrate, wherein the plurality of bumps are not directly coupled to the optical transmitter driver component.

12. The apparatus of claim 11, wherein the optoelectronic assembly further includes a passivation layer between the optical transmitter component and the plurality of bumps, and a conductive structure between the optical transmitter component and the plurality of bumps, wherein the conductive structure is electrically coupled to the plurality of bumps.

13. The apparatus of claim 11, wherein a bump density of the plurality of bumps is greater than approximately 8%.

14. The apparatus of claim 11, wherein a thickness of the plurality of bumps is approximately 30 micron or less.

15. The apparatus of claim 11, wherein the optoelectronic assembly further includes a metallization layer positioned between and coupled to the optical transmitter driver component and the plurality of bumps, wherein the plurality of bumps couples to the second portion of the packaging substrate.

16. The apparatus of claim 11, wherein the plurality of bumps comprises a plurality of first bumps and a plurality of second bumps, wherein the plurality of first bumps is located between the second side of the optical transmitter driver component and the second portion of the packaging substrate, the plurality of first bumps in contact with the second portion of the packaging substrate, and wherein the plurality of second bumps is located between at least one area adjacent to the second side of the optical transmitter driver component and at least one area adjacent to the second portion of the packaging substrate, the plurality of second bumps in contact with the at least one area adjacent to the second portion of the packaging substrate.

17. A method comprising:
forming a metallization layer proximate a side of an optical transmitter driver component that is furthest from an optical transmitter component;
forming a plurality of bumps below the optical transmitter driver component, wherein the plurality of bumps couple to the metallization layer and a substrate below the plurality of bumps; and
forming a passivation layer between the optical transmitter driver component and the metallization layer.

18. The method of claim 17, further comprising:
electrically coupling and bonding the optical transmitter driver component to an underside of the optical transmitter component; and
wherein forming the metallization layer comprises forming conductive traces.

19. (canceled)

20. The method of claim 17, further comprising forming a plurality of second bumps adjacent to the plurality of bumps and not directly below the optical transmitter driver component, wherein the plurality of second bumps are coplanar with the plurality of bumps.
